(19) United States
(12) Patent Application Publication
(10) Pub. No.: US 2026/0257090 A1
(43) Pub. Date: Sep. 3, 2026

(54) An Apparatus for Restricting Fire in Electric or Alternative Fuelled Vehicles

(71) Applicant: FIRE CONTAINERS LIMITED, Stoke-on-Trent (GB)

(72) Inventor: Neil Darren Pedersen, Staffordshire (GB)

(21) Appl. No.: 18/881,949

(22) PCT Filed: Jun. 30, 2023
(86) PCT No.: PCT/GB2023/051725

§ 371 Date: Jan. 7, 2025

(30) Foreign Application Priority Data
Jul. 7, 2022 (GB) 2210000.2

(51) Int. Cl. A62C 3/07; A62C 3/06; A62C 99/00

(52) U.S. Cl. CPC A62C 3/07; A62C 3/06; A62C 3/16; A62C 99/0072

(57) ABSTRACT

There is provided an apparatus for restricting fire in electric or alternative fuelled vehicles. The apparatus comprises a container, the container comprising: a ramp surround, and a ramp. The ramp is movable between a lowered orientation and a raised orientation. In the lowered orientation, the ramp provides an entrance for a road vehicle to the container. In the raised orientation, the ramp forms a substantially water tight seal with the ramp surround. The apparatus additionally comprises a water tank and water deliver means. The water delivery means delivers water from the water tank to the road vehicle container when the ramp is in the raised position.

### TECHNICAL FIELD

The present disclosure relates to a safety transport system for a motor vehicle. In particular, but not exclusively it relates to a transport system for an electric vehicle or alternative fuelled vehicle that has been involved in a fire or accident.

### BACKGROUND

Electric or alternative fuelled vehicles are becoming increasingly common, as a result of a desire to reduce carbon dioxide emissions. An example of an alternative fuelled vehicle is a hydrogen fuelled vehicle.

Like other road vehicles, electric or alternative fuelled vehicles may catch fire, particularly after an accident. Electric vehicle fires can require significant amounts of water to extinguish, with re-ignition of the fire possible if the vehicle battery pack is damaged or hot. Batteries can also ignite many hours or days later if they sustain physical damage.

To mitigate against the risk of reignition, it has been proposed that following a fire, the battery of the vehicle should be immersed in water or cooled during transit to prevent reignition. As the battery is most likely still attached to the vehicle, this means that the fire damaged vehicle is part-submerged in water or cooled with water sprays.

It is an aim of the present invention to address one or more of the disadvantages associated with the prior art.

### SUMMARY OF THE INVENTION

Aspects and embodiments of the invention provide an apparatus as claimed in the appended claims.

According to an aspect of the invention there is provided an apparatus for restricting fire in electric or alternative fuelled road vehicles. The apparatus comprises a container, the container comprising: a ramp surround, and a ramp. The ramp is movable between a lowered orientation and a raised orientation. In the lowered orientation, the ramp provides an entrance for a road vehicle, such as an electric road vehicle or an alternative fuelled road vehicle, to the container. In the raised orientation, the ramp forms a substantially water tight seal with the ramp surround. The apparatus additionally comprises a water tank and water deliver means. The water delivery means delivers water from the water tank to the road vehicle container when the ramp is in the raised position.

In some examples, the apparatus may comprise a winch that is configured to move an electric or alternative fuelled road vehicle into the container or out of the container when the ramp is in the lowered configuration.

In some examples, the apparatus may comprise a detector, the detector configured to detect a fire within the container and/or to alert a user of the apparatus.

In some examples, the detector may be one of a video camera, an infra-red video camera, a thermocouple, an array of thermocouples, a smoke detector.

In some examples, the apparatus may comprise a means for controlling the flow of water to the container. The means for controlling the flow may comprise a user input or may be automatically controlled in response to the detector.

In some examples, the water tank may comprise an inlet vent in an upper portion of the tank. The water tank may additionally comprise a water inlet valve.

In some examples, the water delivery means may comprise a water spray means and a water flooding means. Selection between the water spray means and the water flooding means may be made automatically following detection of a fire, or by the user input.

In some examples, the water spray means may comprise:

at least one lower water spray nozzle, proximal to the floor of the container, the at least one lower water spray nozzle configured to spray water on an underside of an electric vehicle contained in the container;
at least one mid water spray nozzle, proximal to a mid-portion of a first side and a mid-portion of a second side of the container, wherein the at least one mid water spray nozzle is configured to spray water on a first side and a second side of a road vehicle contained in the container; at least one upper water spray nozzle, configured to spray water onto an upper surface of a road vehicle contained in the container. The water spray means may additionally comprise a water pump that is configured to pressurise the water delivered by the water spray means from the water tank.

In some examples, the floor of the container may comprise a sump, the sump configured to collect water delivered by the water spray means. In these examples, the apparatus may additionally comprise a water return conduit; and a valve. The valve is switchable between a first configuration in which water is delivered from the water tank to the water pump, and a second configuration in which water is delivered from the sump to the water pump via the water return conduit.

In some examples, the water flooding means may comprise a water flood valve. The water flood valve may fluidically connect the water tank and container vessel. The water flood valve may be proximal to a base of the water tank.

In some examples, following delivery of water stored in the water tank to the container, a height of water in the container when a road vehicle is in the container may be in the range of 0.2-0.6 m.

In some examples, at least one side of the container may comprise at least one aperture, the at least one aperture configured to accept a fire hose coupling. A height of the at least one aperture above a floor of the container may be greater than a height of water in the container if an electric or alternative fuelled vehicle is within the container and all of the water in the water tank is delivered to the container.

In some examples, the container may comprise at least one drain valve, configured to drain water from the container.

In some examples, the top of the container may be open to the atmosphere. However, some examples may have hard of soft removable coverings.

In some examples, the apparatus may be fixedly mounted to a goods vehicle, or removably mounted to a goods vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of the apparatus for restricting fire in recovery of road vehicles.

### DETAILED DESCRIPTION

Definition: In the context of this application the word “restrict” is used in the context of the limitation or suppression of an ongoing process, and in the prevention, limitation or suppression of a future process. In this context “restricting fire in road vehicles” may be interpreted to mean preventing the ignition of a fire, preventing the reignition of a fire, or limiting, suppressing or extinguishing a fire after ignition or reignition has occurred.

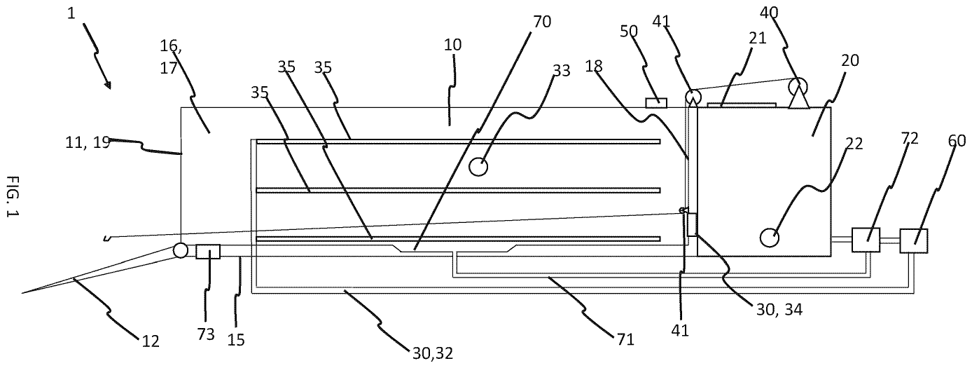

FIG. 1 illustrates an example of an apparatus for restricting fire in electric or alternative fuelled vehicles.

The apparatus for restricting fire in electric or alternative fuelled vehicles comprises a container 10, a water tank 20, and a water delivery means 30 for delivering water 31 from the water tank 30 to the container 10.

The container 10 is sized and shaped such that it can accommodate a road vehicle, particularly an electric or alternative fuelled road vehicle that has previously been damaged for example, in an accident or from having been on fire. Electric or alternative fuelled vehicles which have previously been involved in an accident or have been on fire or have been otherwise damaged may carry a risk of fire or reignition of the earlier fire, after the initial accident or fire has been attended to.

It may be appreciated that the size of the apparatus may be determined by the size of the electric or alternative fuelled vehicle that is to be contained within the container. For example, the size of the apparatus for containing a passenger car may be smaller than the size of the apparatus for containing the tractor unit of a heavy goods vehicle.

Following a fire or collision, the risk of a subsequent fire or reignition may increase when the vehicle is transported away from the scene of the original accident or fire. This is due to increased airflow around the damaged electric or alternative fuelled vehicle or by vibration causing electrodes to touch or move within the battery compartments, caused by the movement of the recovery vehicle on which the vehicle is transported.

FIG. 1 illustrates that the container 10 of the apparatus for restricting fire in electric vehicles 1 comprises a floor 15, a left side 16, a right side 17, a front panel 18 and a rear panel 19. The rear panel comprises a ramp 12, surrounded by a ramp surround 11. When an electric or alternative fuelled vehicle is in the container 10, the height of the left side 16, right side 17, front panel 18 and rear panel 19 is greater than a lower portion of the electric or alternative fuelled vehicle.

In particular, the height of the left side, right side, front panel and rear panel is greater than the height of the battery pack of the electric or alternative fuelled vehicle above the floor 15 of the container 10.

The battery pack of an electric or alternative fuelled vehicle is typically attached to or integral with the floor pan of the electric or alternative fuelled vehicle. This is because the battery pack of an electric or alternative fuelled vehicle is a significant proportion of the total mass of the electric vehicle, with it known that the handling of the electric or alternative fuelled vehicle is improved if the centre of gravity is low. For this reason, the heavier components of the electric or alternative fuelled vehicle, such as the battery pack, are located in the lower portions of the electric vehicle.

The floor 15, left side 16, right side 17, front panel 18 and rear panel 19, comprising the ramp 12 and ramp surround 11of the container 10 form a water tight container when the ramp 12 is in a raised orientation. This is because when the ramp 12 in a raised orientation, a water tight seal is formed between the ramp 12 and ramp surround 11. The water tight seal is achieved by the placement of seals, such as elastomeric seals, between the ramp 12 and ramp surround 11. The seals may be attached to at least one of the ramp 12 and/or ramp surround 11.

It may be appreciated that as the ramp is a movable structure, wear of the seals may occur over time, meaning that some leakage of water may occur between the ramp 12 and ramp surround 11 if the container is partially filled with water, as is subsequently disclosed. In this sense, the seal formed may be watertight or substantially watertight.

The apparatus 1 may be configured to be fixedly mounted to a goods vehicle, or removably mounted to a good vehicle. If removably mounted to a goods vehicle, the apparatus may be removably mounted in either a lift-off configuration, or a roll-off configuration, as is known.

As the apparatus 1 is configured to be mounted to a goods vehicle, the apparatus 1 may be transported to the site of an accident involving an electric or alternative fuelled vehicle or fire involving an electric or alternative fuelled vehicle, for recovery of the electric or alternative fuelled vehicle.

To recover the electric or alternative fuelled vehicle, the ramp 12 is moved from its raised orientation to a lowered orientation, in which the tip of the ramp lies on the surrounding ground.

If driveable, the electric or alternative fuelled vehicle may be driven up the lowered ramp to enter the container 10.

If the electric or alternative fuelled vehicle is undriveable, or it is assessed that the electric or alternative fuelled vehicle may pose a risk if it is attempted to be driven, the electric or alternative fuelled vehicle may be pushed up the ramp, or optionally, a winch cable may be attached to the electric or alternative fuelled vehicle, and a winch used to move the electric or alternative fuelled vehicle into the container. It may be appreciated that the winch may also be used to move the electric or alternative fuelled vehicle out of the container, when unloading.

The winch 40 may be of any suitable type. For example, the winch may be a manual winch, in which the work done in winching the electric or alternative fuelled vehicle up the ramp 12 and into the container 10 is provided by a user-for example, the driver of the goods vehicle on which the apparatus is mounted, or if a power source is available, the winch may be a powered winch, being powered by the goods vehicle or by an external power source such as an electrical battery.

Examples of a powered winch include an electric winch and/or a hydraulic winch.

It is desirable that the line of action of the winch cable is close to the floor 15 of the container 10. In other words, it is desirable that the winch cable runs in the lower portion of the container. This is because pulling of the electric or alternative fuelled vehicle into the container 10 may be done in an efficient manner.

As is subsequently disclosed, the lower portion of the container, may in some circumstances, be flooded by water.

This means that a winch 40 that is placed in the lower portion of the container must be waterproof, being suitable for immersion under water. Alternatively, the winch 40, if not suitable for immersion under water, may be located remote from water within container 10.

FIG. 1. Illustrates an example of this in which winch 40 is remote from container 10, being mounted on an upper portion of water tank 20.

FIG. 1 also illustrates that the apparatus comprises a pulley arrangement 41, comprising two pulleys, such that the line of action of the winch cable is close to the floor 15 of container 10, when winching a road vehicle into the container 10.

Other configurations of winch or winch and pulley arrangement 41 are also envisaged without departing from the scope of the invention. For example, the winch 40 may be located proximal to an upper portion of the front panel 18 of the container 10, or at an intersection between front panel 18 of container 10 and water tank 20, such that the line of action of the winch overhangs the container 10. In these examples, a different pulley arrangement, comprising a single pulley may be used.

Once the electric or alternative fuelled vehicle is moved into the container 10, and the ramp 12 is moved to its raised orientation, forming a watertight seal, or substantially watertight seal with seal surround 12, the vehicle may be removed from the site of the accident or fire, and transported to a safe location.

At this time, the electric or alternative fuelled vehicle may be in a salvageable state, that is, although some parts of the vehicle have been damaged, other parts may be functional. The vehicle may thus be suitable for repair.

However, moving the vehicle may increase the likelihood that a fire re-ignites, or a damaged battery pack ignites. Although this risk could be mitigated by partially filling the container 10 with water, by water delivery means 30 from water tank 20, such that the battery pack of the electric or alternative fuelled vehicle is submerged, and thus cooled, this may create substantial water-damage to the vehicle, such that repair becomes impossible or uneconomic.

In some examples, the apparatus 1 is configured so that the water is only released into the container 10 in response to a detection that a fire has broken out or reignition has occurred within the vehicle, whilst it is in the container 10.

The apparatus 1 may therefore comprise a detector 50. The detector 50 may be configured to detect a fire within the container and/or to alert a user of the apparatus 1 of a fire within the container 10. The detector 50 may be any suitable type of detector, for example, the detector may be a video camera, an infra-red video camera, a thermocouple, an array of thermocouples, or a smoke detector.

In some examples, the detector 50 may be a video camera or an infra-red video camera, that is positioned to observe a road vehicle in the container 10. In other examples, a plurality of video cameras or infra-red video cameras may be used, each positioned to observe a different portion of the road vehicle. The signal or signals from the camera or cameras may be displayed on at least one display screen within the cab of the good vehicle. Thus, a user of the apparatus 1, such as a driver of the goods vehicle may monitor the status of the road vehicle within the container 10.

In some examples, if a fire is detected by, for example, observation by a user of the display screen in the cab of the goods vehicle, the user may by, user input, control a flow of water into the container, the water being delivered by the water delivery means 30.

Different means are envisaged concerning how this may be done. For example, the user may stop the goods vehicle to which the apparatus 1 is mounted and may then actuate at least one mechanism on an external surface of the container 10, to control the flow of water into the container 10.

Alternatively, in other examples, a user input device may be provided such as a button or a switch within the cab of the goods vehicle. The user input device is configured so that actuation of the user input device controls the flow of water into the container 10. In this way, the user is able to control the flow of water into the container 10 while the goods vehicle is in motion. The user may then continue to a safe location, at which the goods vehicle may be stopped.

In other examples, the flow of water may be automatically controlled in response to the detector 50. In these examples, the output of the detector 50 may be compared with a threshold, with the flow of water initiated and controlled in response to the threshold being exceeded. For example, the intensity of an infra-red output of an infra-red camera may be compared with a threshold, a temperature measured by a thermocouple or an array of thermocouples may be compared with a temperature threshold etc.

If the threshold is exceeded, a warning may be additionally provided to the user, by audio, visual or audio-visual means. For example, a warning light may be activated in the cab of the goods vehicle, or an audio warning, may be provided by a loudspeaker in the cab of the goods vehicle.

The controlled flow of water is then delivered by the water delivery means 30 from the water tank 20. The water tank may comprise an inlet vent 21 and an inlet valve 22. The inlet vent 21 may be located in an upper portion of the water tank 20. The inlet vent 21 provides a fluidic connection between the water tank 20 and the surrounding atmosphere. The inlet vent therefore maintains a pressure internal to the water tank 20 at the surrounding pressure of the atmosphere as the level of water in the water tank changes, for example, due to filling the water tank via the inlet valve 22, or extracting water from the water tank by the water delivery means 30.

By equalising the internal pressure of the water tank with the surrounding atmosphere by the inlet vent 21, rapid filling and/or emptying of the water tank 20 is permitted.

Two forms of water delivery means 30 are envisaged: a water spray means 32, and a water flooding means 34. All examples of the apparatus 1 comprise at least one of these water delivery means. However, some examples of the apparatus may comprise both the water spray means 32 and the water flooding means 34.

In examples of the apparatus 1 in which the water delivery means comprises a water spray means 32 and a water flooding means 34; selection between the water spray means 32 and the water flooding means 34 may be made automatically following detection of a fire, or by the user input.

For example, the user input means is configured to enable a user to select which of the water spray means 32 or water flooding 34 means to use, or alternatively selection may be made automatically based upon the magnitude of the exceedance of the detector signal relative to its threshold.

Selection may be desirable because the water spray means 32 is likely to be less damaging to the road vehicle in the container 10 but is also likely to be less effective at restricting fire than the water flooding means 34.

In examples of the apparatus 1 in which the water delivery means comprises both water spray means and water flooding means, it may therefore be desirable to first use the water spray means 32, minimising damage to the road vehicle, until it is apparent that the water flooding means 34 will better restrict the fire.

Examples of the water spray means 32 and water flooding means 34 are now disclosed.

The water spray means 32 comprises at least one water spray nozzle 35. The water spray means 30 may comprise a plurality of water spray nozzles 35. In examples comprising a plurality of water spray nozzles, the plurality of water spray nozzles may be individual, or may be grouped, for examples as spray bars of water spray nozzles.

In the example of FIG. 1, the arrangement of water spray nozzles 35 comprises: -
at least one lower water spray nozzle, proximal to the floor of the container, the at least one lower water spray nozzle configured to spray water on an underside of an electric vehicle contained in the container;
at least one mid water spray nozzle, proximal to a mid-portion of a first side and a mid-portion of a second side of the container, wherein the at least one mid water spray nozzle is configured to spray water on a first side and a second side of an electric vehicle contained in the container;
at least one upper water spray nozzle, configured to spray water onto an upper surface of an electric vehicle contained in the container

It may be appreciated though that other arrangements of water spray nozzles are also possible, without departing from the spirit of the invention.

For example, in some examples of the apparatus 1, only at least one lower water spray nozzle, proximal to the floor of the container may be provided.

Similarly, in embodiments in which multiple spray nozzles are present, means may be provided such that a subset of nozzles may be selected. For example, in the example of FIG. 1 means may be provided such that only the lower nozzles are selected. Selection of which nozzle to use may be made automatically, or in response to user input.

The water spray nozzles deliver a spray of water to the vehicle within the container, cooling the portions of the vehicle to restrict a vehicle fire. For example, lower spray nozzles that are proximal to the floor of the container, that are configured to spray water on an underside of a vehicle may cool the battery of an electric vehicle, the battery being proximal to or integral with the floor pan of the vehicle.

The water spray nozzles are configured to deliver water at pressure.

In some examples, the water spray nozzles may be gravity fed from the water tank 20. In these embodiments, the pressure is based in part on the hydraulic head of the water in the water tank relative to the water spray nozzles 35.

In other examples, the water spray nozzles may be provided with pressurised water by a water pump 60 that is configured to pressurise the water delivered by the water spray means 30 from the water tank 20. This may be advantageous because it increases the pressure at which the water spray nozzles operate relative to a gravity feed, and because the water pump may be used as part of a water spray recirculation loop, for prolonged water spraying. This may be advantageous if the road vehicle in the container 10 is to be transported for a prolonged period, and the user has selected the water spray means be active during transportation, as a preventative measure, to mitigate the risk of a fire starting or reigniting during transport.

In examples in which the water delivered by the water spray means is to be recirculated, the floor 15 of the container 10 comprises a sump 70.

The sump 70 is configured to collect water delivered by the water spray nozzles 35 that has fallen onto the floor 15 of the container 10. In these examples, the sump comprises a water return conduit 71. The water spray means additionally comprises a valve 72.

The water return conduit 71 collects water that pools within the sump 60 and delivers it to the valve 72.

The valve 72 comprises two inlets and one exit. The exit of the valve 72 is fluidically connected to the water pump 50. The first inlet of the valve 72 is fluidically connected to the water tank 30. The second inlet of the valve 72 is fluidically connected to the sump 60 via the water return conduit.

The valve is switchable between a first configuration, in which the exit of the valve is fluidically connected to the first inlet of the valve, but not the second inlet of the valve; and a second configuration in which the exit of the valve is fluidically connected to the second inlet of the valve, but not the first inlet of the valve.

In these examples, the valve is switchable between a first configuration in which water is delivered from the water tank to the water pump, and a second configuration in which water is delivered from the sump 60 to the water pump via the water return conduit.

Switching of the valve may be automatic, for example, based at least in part on the detection of a level of water within the sump, or may be initiated by the user.

In some examples, switching of the valve may require that the water pump is stopped whilst the switchover is made. In other examples, a bypass (not shown) that bypasses the valve may be temporarily opened so that switching may be made without stopping the pump. The bypass (not shown) may then be closed once switchover has occurred.

As previously disclosed, although it may be desirable to minimise further damage to the road vehicle in the container 10, if the water spray system if a fire is not sufficiently restricted by the water spray means, the water flooding means 34 may be used. Alternatively, the water flooding 34 means may be used in preference to the water spray means 32.

The water flooding means 34 may comprise a water flood valve, the water flood valve fluidically connecting the water tank 20 and container 10, the water flood valve being proximal to a base of the water tank, the base of the water tank being at least at the height of the floor 15 of the container. As the water flood valve is proximal to the base of the water tank, water flooding of the container 10 by water stored in the water tank 20 may be gravity driven. In other words, a pump is not required for the water to flow through the water flood valve and into the container 10, when the water flood valve is opened.

Following delivery of water stored in the water tank to the container, a height of water in the container when a road vehicle is in the container may be in the range of 0.2-0.6 m. This may be increased by supplementing a water supply to the water inlets.

This range may be selected such that if an electric or alternative fuelled vehicle is within the container, the battery of the electric vehicle may be submerged under the surface of the water in the container. This is advantageous because water cooling is provided to the battery, restricting a battery fire.

It may be appreciated that alternative ranges may be used, based in part upon the dimensions of the vehicle to be contained in the container. For example, a higher maximum range may be used if a tractor unit for a heavy goods vehicle is to be transported, relative to that required for a passenger car or a light commercial vehicle such as a van.

It may be appreciated that despite use of either or both of the water flooding means and/or water spray means, in some circumstances, a fire may not be restrained. The container 10 therefore may additionally comprise at least one aperture 33, the at least one aperture 33 configured to accept a fire hose nozzle. The aperture may be located in a side of the container (for example, a left side or a right side), or a front or rear panel of the container. The aperture may be provided with a sealing means, such that the aperture is substantially sealed when not in use.

The height of the at least one aperture above a floor of the container may be greater than a height of water in the container if an electric or alternative fuelled vehicle is within the container and all of the water in the water tank is delivered to the container. In this way, water delivered by the water delivery means 30 from the water tank 20 to the container 10 may be prevented from leaving the container 10.

The at least one aperture may permit fire service personnel to add additional water to the container and/or fight a fire within the container.

The container 10 may additionally comprise at least one drain valve 73. The at least one drain valve may be located in the floor 15, or proximal to the floor 15 of the container 10. The at least one drain valve 73 provides a controlled means by which water may be drained from the container, as an alternative to moving the ramp 12 to its lowered orientation, breaking the substantially watertight seal between the ramp 12 and ramp surround 11.

In some examples, the top of the container 10 may be open to the atmosphere. As the top of the container 10 is open to the atmosphere, the likelihood of pressure-wave damage, initiated by an explosion of a road vehicle, or part of a road vehicle such as the battery pack of an electric or alternative fuelled vehicle, may be mitigated.

In some examples, a removable, flexible, fireproof cover may cover the top of the container 10. This may have the advantage that entrainment of airflow into the container may be reduced. This may be beneficial in reducing the probability that reignition of a fire occurs while the vehicle a vehicle is contained within the container 10.

As previously disclosed, in some examples, the apparatus 1 is removably mounted to a goods vehicle. This has the advantage that, following recovery from a fire or accident, a road vehicle may need to spend a prolonged time period within the container 10.

In examples in which the container is removably mounted, once the goods vehicle to which the container is removably mounted has returned to its base, or depot, the container containing the damaged road vehicle may be removed from the vehicle, and a second container mounted to the goods vehicle. Thus, the goods vehicle may return to its road vehicle recovery duties, whilst the road vehicle remains in the container 10 that has been removed.

Once the container has been removed from the vehicle, for example, at a depot, the detector and controller (if present) may remain active. That is, in these examples, the apparatus may still comprise means for controlling the flow of water to the container, wherein the means for controlling the flow comprises a user input or is automatically controlled in response to the detector.

Although embodiments of the present invention have been described in the preceding paragraphs with reference to various examples, it should be appreciated that modifications to the examples given can be made without departing from the scope of the invention as claimed.

For example, although the apparatus is disclosed as an apparatus tor restricting fire in electric or alternative fuelled vehicles, the apparatus may also restrict fire in other types of road vehicle.

For example, the apparatus may restrict fire in internal-combustion engine powered road vehicles, in hybrid road vehicle whose powertrain comprises both an internal combustion engine, an electric motor and a battery.

For hydrogen powered vehicles, as an example of alternative fuelled vehicles, the hydrogen may be stored as a compressed gas, cryogenic liquid, or by adsorption or absorption processed within a matrix. It may be appreciated that the cooling provided by the apparatus is advantageous in ensuring that the vehicle energy source (electric battery, hydrocarbon fuel tank, hydrogen storage apparatus) remains stable after a vehicle accident or fire. Hydrogen powered vehicles may comprise either a fuel cell or internal combustion engine.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for restricting fire in a road vehicle, wherein the road vehicle is an electric or alternative fuelled vehicle, the apparatus comprising:
a container, the container comprising:
a ramp surround, and a ramp, wherein the ramp is movable between a lowered orientation and a raised orientation, wherein:
in the lowered orientation, the ramp provides an entrance for the road vehicle to the container; and
in the raised orientation, the ramp forms a substantially water tight seal with the ramp surround;
a water tank; and
a water delivery system configured to deliver water from the water tank to the electric vehicle container when the ramp is in the raised position;
wherein the water delivery system comprises a water spray system, and the water spray system comprises a water pump, configured to pressurise the water delivered by the water spray system; and
wherein a floor of the container comprises a sump, the sump configured to collect water delivered by the water spray system;
a water return conduit; and
a valve, switchable between a first configuration in which water is delivered from the water tank to the water pump, and a second configuration in which water is delivered from the sump to the water pump via the water return conduit.

2. An apparatus as claimed in claim 1, wherein the apparatus comprises a winch that is configured to move the road vehicle into the container or out of the container when the ramp is in the lowered configuration.

3. An apparatus as claimed in claim 1, wherein the apparatus comprises a detector, the detector configured to detect a fire within the container and/or to alert a user of the apparatus.

4. An apparatus as claimed in claim 3, wherein the detector is one of a video camera, an infra-red video camera, a thermocouple, an array of thermocouples, a smoke detector.

5. An apparatus as claimed in claim 3, wherein the apparatus is configured to control the flow of water to the container, wherein controlling the flow of water to the container comprises a user input or is automatically controlled in response to the detector.

6. An apparatus as claimed in claim 1, wherein the water tank comprises an inlet vent in an upper portion of the tank and a water inlet valve.

7. An apparatus as claimed in claim 1, wherein the water delivery system further comprises a water flooding system; wherein selection between the water spray system and the water flooding system is made automatically following detection of a fire, or by the user input.

8. An apparatus as claimed in claim 1, wherein the water spray system comprises:
at least one lower water spray nozzle, proximal to the floor of the container, the at least one lower water spray nozzle configured to spray water on an underside of the road vehicle contained in the container;
at least one mid water spray nozzle, proximal to a mid-portion of a first side and a mid-portion of a second side of the container, wherein the at least one mid water spray nozzle is configured to spray water on a first side and a second side of the road vehicle contained in the container; and
at least one upper water spray nozzle, configured to spray water onto an upper surface of the road vehicle contained in the container.

9. An apparatus as claimed in claim 7, wherein the water flooding system comprises a water flood valve, the water flood valve fluidically connecting the water tank and container vessel, the water flood valve being proximal to a base of the water tank.

10. An apparatus as claimed in claim 1, wherein following delivery of all of the water stored in the water tank to the container, a height of water in the container when the road vehicle is in the container is in the range of 0.2-0.6 m.

11. An apparatus as claimed in claim 1, wherein at least one side of the container comprises at least one aperture, the at least one aperture configured to accept a fire hose coupling.

12. An apparatus as claimed in claim 11, wherein a height of the at least one aperture above a floor of the container is greater than a height of water in the container if the road vehicle is within the container and all of the water in the water tank is delivered to the container.

13. An apparatus as claimed in claim 1, wherein the container comprises at least one drain valve, configured to drain water from the container.

14. An apparatus as claimed in claim 1, wherein the top of the container is open to the atmosphere.

15. An apparatus as claimed in claim 1, wherein the apparatus is fixedly mounted to a goods vehicle, or removably mounted to a goods vehicle.

16. An apparatus as claimed in claim 15, wherein a warning light is configured to be activated in a cab of the goods vehicle, or a loudspeaker is configured to provide an audio warning in the cab of the goods vehicle.

17. An apparatus as claimed in claim 1, wherein the sump is located in a central region of the floor, wherein the central region of the floor is located between raised left and right surfaces of the floor.

18. An apparatus as claimed in claim 1, wherein the water spray system comprises a plurality of rows of spray bars of water spray nozzles.

19. An apparatus as claimed in claim 18, wherein the plurality of rows of sprays bars of water spray nozzles comprises at least one lower spray bar of water spray nozzles, proximal to the floor of the container, the at least one lower spray bar of water spray nozzles configured to spray water on an underside of the road vehicle contained in the container.

20. An apparatus as claimed in claim 19, wherein the water spray system further comprises:
at least one mid water spray bar of water spray nozzles, proximal to a mid-portion of a first side and a mid-portion of a second side of the container, wherein the at least one mid water spray bar of water spray nozzles is configured to spray water on a first side and a second side of the road vehicle contained in the container; and
at least one upper water spray bar of water spray nozzles, wherein the at least one upper water spray bar of water spray nozzles is configured to spray water onto an upper surface of the road vehicle contained in the container.
